(19) United States
(12) Patent Application Publication
(10) Pub. No.: US 2005/0066146 A1
(43) Pub. Date: Mar. 24, 2005

(54) Endian conversion

(75) Inventors: Peter J. Barry, Ardnacrusha (IE); Eirik N. Esp, Nashua, NH (US); Gavin J. Stark, Fremont, CA (US); Steven W. Zagorianakos, Brookline, NH (US)

Correspondence Address: FISH & RICHARDSON, PC, 12390 EL CAMINO REAL, SAN DIEGO, CA, 92130-2081, US

(73) Assignee: Intel Corporation

(21) Appl. No.: 10/665,976

(22) Filed: Sep. 19, 2003

(51) Int. Cl. G06F 12/08

(52) U.S. Cl. 711/201

(57) ABSTRACT

Techniques that define a type of endian conversion to be performed on a portion of data stored within a memory system are described. A table entry is written to a memory management table that specifies the location of the portion of data within the memory system and the type of endian conversion to be performed on the portion of data.

### BACKGROUND

Computer architectures typically incorporate multiple processing units (i.e., processors) that are interconnected by one or more buses.

Generally, processors can be divided into two distinct architecture families, namely big-endian, and little-endian. The “endianess” of a processor refers to which bytes of a multi-byte word the processor considers to be most significant bytes of the word.

In big-endian processors, the left-most byte (i.e., the byte with the lower address) is the most significant; while in little-endian processors, the right-most byte (i.e., the byte with the higher address) is the most significant.

In a multi-processor computer architecture that includes both big-endian and little-endian processors, special conversion procedures are used when transferring data between processors having different endian architectures.

### DESCRIPTION OF DRAWINGS

FIG. 1 is a block diagram of a computer architecture including an endian conversion management system; and

FIG. 2 is a block diagram of the endian conversion management system of FIG. 1.

### DETAILED DESCRIPTION

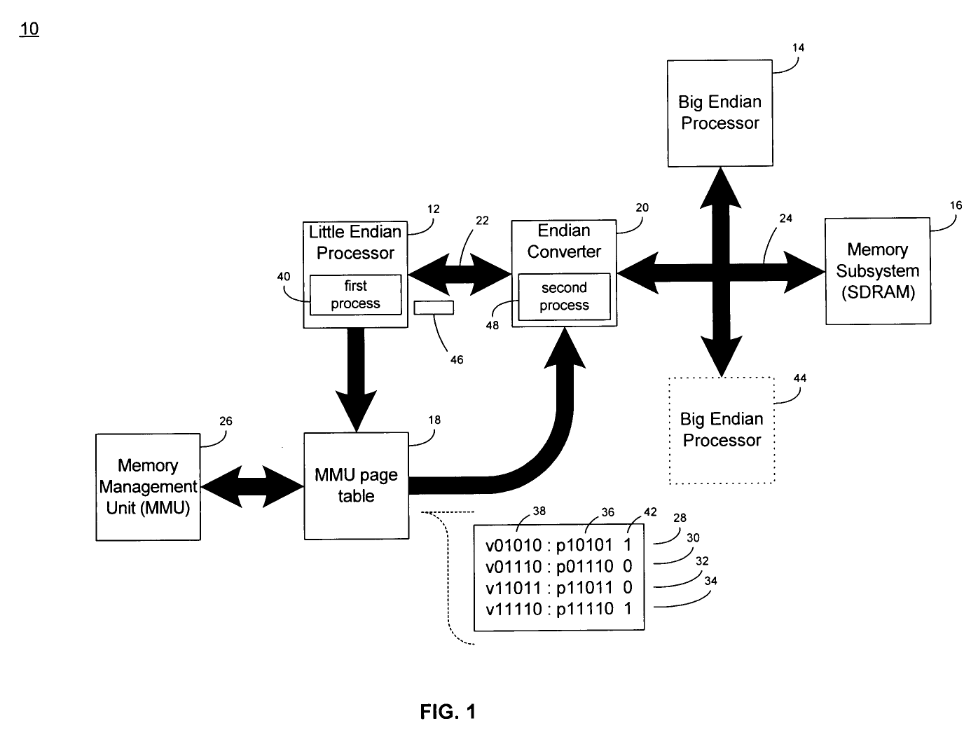

Referring to FIG. 1, computer architecture 10 includes multiple processors 12 and 14, memory subsystem 16, memory management unit (MMU)26, and an MMU page table structure 18 that typically resides in processor memory. Computer architecture 10 may be incorporated into various networking devices (not shown), such as switches, routers, hubs, access points, and Ethernet adapters. As processor 12 is a little-endian processor and processor 14 is a big-endian processor, an endian converter 20 is included in architecture 10. Buses 22 and 24 interconnect the above-mentioned devices of computer architecture 10.

When converting between endian types, endian converter 20 can convert data using either “address coherent conversion” or “data coherent conversion.”

In address coherent conversion, a data address of a first endian type is converted into a data address of a second endian type. For data coherent conversion, the bytes within a data word are swapped, such that (for a four byte word) the first and fourth bytes are swapped, and the second and third bytes are swapped. Each of these conversion types will be explained below in greater detail.

The following Table 1 summarizes address coherency conversion.

TABLE 1

| if a little-endian | | | a big-endian processor | | |
|---|---|---|---|---|---|
| processor writes the data | | | will read the data this | | |
| this way: | | | way: | | |
| Size | Address | Data | Size | Address | Data |
| byte | 0 | AA | byte | 3 | AA |
| byte | 1 | BB | byte | 2 | BB |
| byte | 2 | CC | byte | 1 | CC |
| byte | 3 | DD | byte | 0 | DD |
| | | | half-word | 2 | AABB |
| | | | half-word | 0 | CCDD |
| | | | word | 0 | AABBCCDD |
| Half- | 0 | AABB | byte | 3 | AA |
| word | | | | | |
| Half = | 2 | CCDD | byte | 2 | BB |
| word | | | byte | 1 | CC |
| | | | byte | 0 | DD |
| | | | half-word | 2 | AABB |
| | | | half-word | 0 | CCDD |
| | | | word | 0 | AABBCCDD |
| word | 0 | AABBCCDD | byte | 3 | AA |
| | | | byte | 2 | BB |
| | | | byte | 1 | CC |
| | | | byte | 0 | DD |
| | | | half-word | 2 | AABB |
| | | | half-word | 0 | CCDD |
| | | | word | 0 | AABBCCDD |

The following Table 2 summarizes data coherency conversion.

TABLE 2

| if a little-endian | | | a big-endian processor | | |
|---|---|---|---|---|---|
| processor writes the data | | | will read the data this | | |
| this way: | | | way: | | |
| Size | Address | Data | Size | Address | Data |
| byte | 0 | AA | byte | 0 | AA |
| byte | 1 | BB | byte | 1 | BB |
| byte | 2 | CC | byte | 2 | CC |
| byte | 3 | DD | byte | 3 | DD |
| | | | half-word | 0 | BBAA |
| | | | half-word | 2 | DDCC |
| | | | word | 0 | DDCCBBAA |
| half- | 0 | AABB | byte | 0 | AA |
| word | | | | | |
| half = | 2 | CCDD | byte | 1 | BB |
| word | | | byte | 2 | CC |
| | | | byte | 3 | DD |
| | | | half-word | 0 | BBAA |
| | | | half-word | 2 | DDCC |
| | | | word | 0 | DDCCBBAA |
| word | 0 | AABBCCDD | byte | 0 | AA |
| | | | byte | 1 | BB |
| | | | byte | 2 | CC |
| | | | byte | 3 | DD |
| | | | half-word | 0 | BBAA |
| | | | half-word | 2 | DDCC |
| | | | word | 0 | DDCCBBAA |

Depending on the type of procedure being performed by the processors 12 and 14, it may be preferable to do either an address coherent conversion or data coherent conversion. An example of a situation in which an address coherent conversion is preferred is when porting drivers from big endian systems. However, if the peripheral is mapped in address coherent mode, the drivers will not need conversion. An example of a situation in which a data coherent conversion is preferred is when reading Internet protocol packets that were written into SDRAM by a big endian processor.

Memory management unit (MMU) 26 is a device that supports virtual memory and memory paging by translating virtual memory addresses into physical memory addresses. Memory management unit 26 can be a stand-along unit or, more typically, is incorporated into a processor, such as little-endian process 12.

Processors, such as processors 12 and 14, use a virtual memory address space that is divided into memory pages. These memory pages are of various sizes, typically kilobytes in size (e.g., 1024, 2048, etc. bytes).

MMU page table 18 is maintained by memory management unit 26 in SDRAM (i.e., synchronous dynamic random access memory). MMU page table 18 includes page table entries 28, 30, 32, and 34, for example, each of which provide a physical memory address (e.g., address 36) usable by memory subsystem 16 to access physical memory. The physical address corresponds with a virtual memory address (e.g., address 38) usable by processors 12 and 14).

In addition to the address conversion information described above, a page table entry may also include information concerning whether the memory page has been written to, when the page was last accessed, what kind of processes (e.g., user mode, supervisor mode) may read and write the memory page, and whether the memory page should be cached, for example.

Processor 12 includes a first process 40 of an endian conversion management system. First process 40 adds a conversion-type indicator 42 into each of the page table entries. Conversion-type indicator 42 specifies the type of endian conversion to be performed on the portion of data stored at the memory location specified by that table entry. Typically, conversion-type indicator 42 is a single bit that specifies one of two types of endian conversions, namely address coherent conversions and data coherent conversions.

As described above, processor 12 is a little-endian processor and processor 14 is a big-endian processor. Accordingly, any portions of data transferred between these processors will need to be converted into the proper endian format. This data conversion is handled by endian converter 20.

As already discussed, certain procedures are more efficiently performed by using certain types of endian conversions. For example, it might be more efficient when transferring data from processor 12 to processor 14 to use a data coherent endian conversion. However, when transferring data to a third processor 44 (shown in phantom), it may be more efficient to use address coherent endian conversions. Therefore, the type of endian conversion varies based on the processor or process receiving the data.

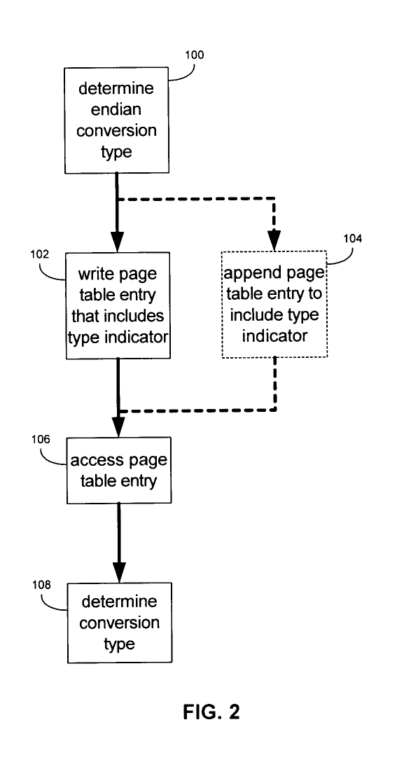

Referring to FIG. 2, first process 40 of the endian conversion management system determines 100 the type of endian conversion to be performed on a portion of data that is transferred from a first processor to a second processor. Typically, this portion of data is a full word, a half word, or a byte. Determining the conversion type may be based on a set of rules concerning, for example, the type of data being transferred, the intended recipient of the data, or the operation being performed on the data, for example. For address coherent conversions, the address space used by a peripheral may be fixed and the MMU page table 18 may be provisioned with the address coherent translation. For data coherent conversions, the memory packet may be allocated from a larger pool of memory. As the endian conversion management system knows that the pool of memory is to be used for data packets, first process 40 may change the conversion-type indicator 42 in the MMU page table before the memory is actually referenced.

A conversion is not required when the data is being transferred between processors having a common endian format (i.e., big-endian to big-endian, or little-endian to little-endian).

Assume, for this example, that all transfers between little-endian processor 12 and big-endian processor 14 should be converted using a data coherent conversion, while all transfers between little-endian processor 12 and big-endian processor 44 should be converted using an address coherent conversion.

Accordingly, whenever a portion of data, such as word 46, is being transferred from a first processor to a second processor, first process 40 determines 100 the type of conversion to be performed. If word 46 is being transferred from little-endian processor 12 to big-endian processor 14, a data coherent conversion will be used (as demonstrated above in Table 2). To effectuate this data transfer, word 46 is written to memory so that it could subsequently be read by processor 14. Since processors execute instructions and store data within a virtual memory address space, memory management unit 26 writes a page table entry (e.g., entry 28) into MMU page table 18 that maps the virtual memory address used by processor 12 to the physical memory address at which the word 44 of data is stored.

Assume that a binary “0” is used to define an address coherent conversion and a binary “1” is used to define a data coherent conversion. Since the data transfer from processor 12 to processor 14 uses data coherent conversion, as was defined above, a binary “1” conversion-type indicator will be included in page table entry 28. Typically, this conversion-type indicator is provided to memory management unit 26 so that, when writing 102 page table entry 28 to MMU page table 18, the conversion-type indicator can be included in the page table entry. Alternatively, first process 40 may append 104 the page table entry to include the conversion-type indicator.

Prior to endian converter 20 converting the data, a second process 48 of the endian conversion management system accesses 106 the page table entry for the portion of data to be converted to determine 108 the type of conversion to be performed. Continuing with the above-stated example, when endian converter 20 is ready to convert word 46, second process 48 accesses page table entry 28 (i.e., the page table entry that corresponds to word 46) to determine the type of conversion to be performed prior to writing word 46 to memory subsystem 16.

Since the conversion-type indicator 42 is a binary “1”, endian converter 20 performs a data coherent conversion on word 46 prior to writing word 46 to memory 16. Accordingly, the little-endian word 46 provided by little-endian processor 12 is converted into a big-endian format using a data coherent conversion so that word 46 is readable by big-endian processor 14.

Typically, once word 46 is converted and written to memory, the particular page table entry (i.e., entry 28) that corresponds to word 46 is removed from MMU page table 18 by memory management unit 26.

Accordingly, by assigning a conversion-type indicator to each entry in the MMU page table 18, conversion granularity is enhanced, as it allows for the endian conversion of portions of data on a per byte, half word, word, or page basis.

While the above-described example is shown to perform one type of conversion for a first processor and another type of conversion for a second processor, other configurations are possible. For example, the type of conversion may be based on the data type or the transaction type, for example.

While the endian conversion management system is shown as being incorporated to a processor and an endian converter, other configurations are possible. For example, the endian conversion management system may be wholly or partially incorporated into the memory management unit. Further, the memory management unit may be incorporated into the processor itself or a stand-alone device.

The described system is not limited to the implementations described above, as it may find applicability in any computing or processing environment. The system may be implemented in hardware, software, or a combination of the two. For example, the system may be implemented using circuitry, such as one or more of programmable logic (e.g., an ASIC), logic gates, a processor, and a memory.

The system may be implemented in computer programs executing on programmable computers, each of which includes a processor and a storage medium readable by the processor (including volatile and non-volatile memory and/or storage elements). Each such program may be implemented in a high-level procedural or object-oriented programming language to communicate with a computer system. However, the programs can be implemented in assembly or machine language. The language may be a compiled language or an interpreted language.

Each computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the system.

The system may also be implemented as a machine-readable storage medium, configured with a computer program, where, upon execution, instructions in the computer program cause a machine to operate to perform the functions of the system described above.

Implementations of the system may be used in a variety of applications. Although the system is not limited in this respect, the system may be implemented with memory devices in microcontrollers, general purpose microprocessors, digital signal processors (DSPs), reduced instruction-set computing (RISC), and complex instruction-set computing (CISC), among other electronic components.

Implementations of the system may also use integrated circuit blocks referred to as main memory, cache memory, or other types of memory that store electronic instructions to be executed by a microprocessor or store data that may be used in arithmetic operations.

A number of implementations have been described. Nevertheless, it will be understood that various modifications may be made. Accordingly, other implementations are within the scope of the following claims.

1. A method comprising:
determining a type of endian conversion to be performed on a portion of data stored within a memory system; and
writing a table entry to a memory management table that specifies the type of endian conversion to be performed on the portion of data.

2. The method of claim 1 wherein writing a table entry to a memory management table further includes specifying the location of the portion of data within the memory system.

3. The method of claim 1 wherein the type of endian conversion is a data coherent conversion.

4. The method of claim 1 wherein the type of endian conversion is an address coherent conversion.

5. The method of claim 1 wherein the table entry includes a single bit for specifying one of two types of endian conversion.

6. The method of claim 1 wherein the table entry maps a virtual memory address to a physical memory address.

7. A method comprising:
maintaining a memory management table that includes one or more table entries, each table entry defining a location of a portion of data stored within a memory system and a type of endian conversion to be performed on the portion of data.

8. The method of claim 7 wherein the type of endian conversion is a data coherent conversion.

9. The method of claim 7 wherein the type of endian conversion is an address coherent conversion.

10. The method of claim 7 wherein the table entry includes a single bit for specifying one of two types of endian conversion.

11. The method of claim 7 wherein the portion of data is stored at a physical memory address within a memory system.

12. The method of claim 11 wherein the table entry maps the physical address at which the portion of data is stored to a virtual address accessible by a processor.

13. A computer program product residing on a computer readable medium having a plurality of instructions stored thereon which, when executed by the processor, cause that processor to:
determine a type of endian conversion to be performed on a portion of data stored within a memory system; and
write a table entry to a memory management table that specifies the location of the portion of data within the memory system and the type of endian conversion to be performed on the portion of data.

14. The computer program product of claim 13 wherein the type of endian conversion is a data coherent conversion.

15. The computer program product of claim 13 wherein the type of endian conversion is an address coherent conversion.

16. The computer program product of claim 13 wherein the table entry includes a single bit for specifying one of two types of endian conversion.

17. The computer program product of claim 13 wherein the table entry maps a virtual memory address to a physical memory address.

18. A computer program product residing on a computer readable medium having a plurality of instructions stored thereon which, when executed by the processor, cause that processor to:
maintain a memory management table that includes one or more table entries each table entry defining a location of a portion of data stored within a memory system and a type of endian conversion to be performed on the portion of data.

19. The computer program product of claim 18 wherein the type of endian conversion is a data coherent conversion.

20. The computer program product of claim 18 wherein the type of endian conversion is an address coherent conversion.

21. The computer program product of claim 18 wherein the table entry includes a single bit for specifying one of two types of endian conversion.

22. The computer program product of claim 18 wherein the portion of data is stored at a physical memory address within a memory system.

23. The computer program product of claim 19 wherein the table entry maps the physical address at which the portion of data is stored to a virtual address accessible by a processor.

24. A memory management table residing in computer memory comprising:
one or more table entries, with each table entry having a first field for defining the location of a portion of data stored within a memory system and a second field for defining a type of endian conversion to be performed on the portion of data.

25. The memory management table of claim 24 wherein each table entry includes a single bit for specifying one of two types of endian conversion.

26. The memory management table of claim 25 wherein one type of endian conversion is a data coherent conversion.

27. The memory management table of claim 25 wherein one type of endian conversion is an address coherent conversion.

28. The memory management table of claim 25 wherein each table entry maps a virtual memory address to a physical memory address.

29. A system comprising:
a first processor for processing data in a first endian format;
a second processor for processing data in a second endian format;
a bus for interconnecting the first and second processors;
an endian converter for converting portions of data from the first endian format to the second endian format; and
a memory management table including one or more table entries, with each table entry defining a location for a portion of data to be converted from the first endian format to the second endian format, and a type of endian conversion to be performed on the portion of data by the endian converter.

30. The system of claim 29 wherein the type of endian conversion is a data coherent conversion.

31. The system of claim 29 wherein the type of endian conversion is an address coherent conversion.

32. The system of claim 29 wherein the first processor is a little-endian processor.

33. The system of claim 29 wherein the second processor is a big-endian processor.

34. A computer architecture comprising:
a networking device, including:
a first processor for processing data in a first endian format;
a second processor for processing data in a second endian format;
a bus for interconnecting the first and second processors;
an endian converter for converting portions of data from the first endian format to the second endian format; and
a memory management table including one or more table entries, wherein each table entry defines a location for a portion of data to be converted from the first endian format to the second endian format, and a type of endian conversion to be performed on the portion of data by the endian converter.

35. The architecture of claim 34 wherein the type of endian conversion is a data coherent conversion.

36. The architecture of claim 34 wherein the type of endian conversion is an address coherent conversion.

37. The architecture of claim 34 wherein the first processor is a little-endian processor.

38. The architecture of claim 34 wherein the second processor is a big-endian processor.

39. A method comprising:
accessing a table entry of a memory management table, wherein the table entry is associated with a portion of data stored within a memory system and includes a conversion-type indicator; and
determining a type of endian conversion to be performed on the portion of data based on the conversion-type indicator.

40. The method of claim 39 wherein the type of endian conversion is a data coherent conversion.

41. The method of claim 39 wherein the type of endian conversion is an address coherent conversion.

42. The method of claim 39 wherein the conversion-type indicator includes a single bit for specifying one of two types of endian conversion.

43. A computer program product residing on a computer readable medium having a plurality of instructions stored thereon which, when executed by the processor, cause that processor to:
access a table entry of a memory management table, wherein the table entry is associated with a portion of data stored within a memory system and includes a conversion-type indicator; and
determine a type of endian conversion to be performed on the portion of data based on the conversion-type indicator.

44. The computer program product of claim 43 wherein the type of endian conversion is a data coherent conversion.

45. The computer program product of claim 43 wherein the type of endian conversion is an address coherent conversion.

46. The computer program product of claim 43 wherein the conversion-type indicator includes a single bit for specifying one of two types of endian conversion.

47. A method comprising:
determining a type of endian conversion to be performed on a portion of a page stored within a memory system; and
writing a table entry to a memory management table that specifies the type of endian conversion to be performed on the portion of the page.

48. The method of claim 47 wherein writing a table entry to a memory management table further includes specifying the location of the portion of the page within the memory system.

49. The method of claim 47 wherein the type of endian conversion is a data coherent conversion.

50. The method of claim 47 wherein the type of endian conversion is an address coherent conversion.
